(19) United States
(12) Patent Application Publication
(10) Pub. No.: US 2004/0146604 A1
(43) Pub. Date: Jul. 29, 2004

(54) Process for producing low fat cheese

(75) Inventor: Sabry Madkor, Raleigh, NC (US)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Chr. Hansen A/S, Hoersholm (DK); Novozymes North America, Inc., Franklinton, NC

(21) Appl. No.: 10/736,750

(22) Filed: Dec. 16, 2003

Related U.S. Application Data
(60) Provisional application No. 60/434,008, filed on Dec. 17, 2002.
(60) Provisional application No. 60/434,689, filed on Dec. 18, 2002.

(51) Int. Cl. A23C 9/12

(52) U.S. Cl. 426/36

(57) ABSTRACT

The present invention relates to a method for producing cheese with a low fat content from cows milk wherein milk or a fraction of milk is treated with a phospholipase, and the treated milk or milk fraction is used for producing cheese. The method results in a decreased oiling off of the cheese when heated, and/or in an improved cheese yield.

### CROSS-REFERENCE TO RELATED APPLICATIONS

This application claims, under 35 U.S.C. 119, U.S. application No. 60/434,008, filed Dec. 17, 2002 and Ser. No. 60/434,689, filed Dec. 18, 2002, the contents of which are fully incorporated herein by reference.

### TECHNICAL FIELD

The present invention relates to a process for producing cheese from an enzyme-treated dairy composition.

### BACKGROUND OF THE INVENTION

During traditional production of cheese the milk is coagulated by acidification and/or addition of rennet. After coagulation the milk is separated into curd and whey and the whey is drained away from the curd. The cheese is produced by further processing of the curd, whereas the whey is a by-product of the cheese making process. The caseins constitute the major part of the milk protein. The main part of the casein is retained in the curd but some casein, as well as fat, is lost in the whey. Since the cheese is a more valuable product than the whey, there is a desire to reduce the amount of casein and fat lost in the whey and increase the yield of cheese from a volume of milk.

Increased consumer awareness of the health benefits of foods with reduced fat content has increased the need for cheeses with a fat content lower than the usual fat content of between 30 and 60% fat in dry matter.

There is a thus a need for improved methods for the manufacture of cheese, in particular methods for improving the cheese yield when producing low fat cheese.

WO 00/54601 discloses a method for improving the stability of the fat phase of cheese, comprising the steps of a) treating the cheese milk with a phospholipase and b) producing cheese from the cheese milk.

### SUMMARY OF THE INVENTION

It has surprisingly been found that when cheese with a fat content of 5% or less fat in dry matter, is produced from a dairy composition comprising cow's milk and/or one or more cow's milk fractions that has been treated with phospholipase, the cheese yield is increased.

The present invention thus relates to a method for producing cheese with 5% or less fat in dry matter, comprising:

a) treating a dairy composition comprising cow's milk and/or one or more cow's milk fractions, with a phospholipase;

b) producing cheese from said phospholipase treated dairy composition.

A further aspect of the invention relates to a method for producing cheese, comprising:

a) treating a dairy composition with 5% or less fat in dry matter comprising cow's milk and/or one or more cow's milk fractions, with a phospholipase; and

b) producing cheese from said phospholipase treated dairy composition.

A still further aspect of the invention relates to a cheese produced by a method of the invention.

### DETAILED DISCLOSURE OF THE INVENTION

Production of Cheese:

In the present context, the term “cheese” refers to any kind of cheese and such as, e.g., natural cheese, cheese analogues and processed cheese. The cheese may be obtained by any suitable process known in the art, such as, e.g., by enzymatic coagulation of a dairy composition with rennet, or by acidic coagulation of a dairy composition with food grade acid or acid produced by lactic acid bacteria growth. In one embodiment, the cheese manufactured by the process of the invention is rennet-curd cheese. Rennet is commercially available, e.g. as Naturen® (animal rennet), Chy-max® (fermentation produced chymosin), Microlant® (Microbial coagulant produced by fermentation), all from Chr. Hansen A/S, Denmark). The dairy composition may be subjected to a conventional cheese-making process.

Processed cheese is preferably manufactured from natural cheese or cheese analogues by cooking and emulsifying the cheese, such as, with emulsifying salts (e.g. phosphates and citrate). The process may further include the addition of spices/condiments. The term “cheese analogues” refers to cheese-like products which contain fat (such as, e.g., milk fat (e.g., cream) as a part of the composition, and which further contain, as part of the composition, a non-milk constituents, such as, e.g., vegetable oil.

The cheeses produced by the process of the present invention comprise all varieties of cheese, such as, e.g. Campesino, Chester, Danbo, Drabant, Herregard, Manchego, Provolone, Saint Paulin, Soft cheese, Svecia, Taleggio, White cheese, including rennet-curd cheese produced by rennet-coagulation of the cheese curd; ripened cheeses such as Cheddar, Colby, Edam, Muenster, Gruyere, Emmenthal, Camembert, Parmesan and Romano; blue cheese, such as Danish blue cheese; fresh cheeses such as Mozzarella and Feta; acid coagulated cheeses such as cream cheese, Neufchatel, Quarg, Cottage Cheese and Queso Blanco; and pasta filata cheese. One embodiment relates to the production of pizza cheese by the process of the invention.

In cheese manufacture, the coagulation of a dairy composition is preferably performed either by rennet or by acidification alone resulting in rennet-curd and acid-curd cheese, respectively, making up two major groups of cheese types. Fresh acid-curd cheeses refer to those varieties of cheese produced by the coagulation of milk, cream or whey via acidification or a combination of acid and heat, and which are ready for consumption once the manufacturing without ripening is completed. Fresh acid-curd cheeses generally differ from rennet-curd cheese varieties (e.g. Camembert, Cheddar, Emmenthal) where coagulation normally is induced by the action of rennet at pH values 6.4-6.6, in that coagulation normally occurs close to the isoelectric point of casein, i.e. e.g. at pH 4.6 or at higher values when elevated temperatures are used, e.g. in Ricotta at pH typically about 6.0 and temperature typically about 80° C. In a preferred embodiment of the invention, the cheese belongs to the class of rennet curd cheeses.

Mozzarella is a member of the so-called pasta filata, or stretched curd, cheeses which are normally distinguished by a unique plasticizing and kneading treatment of the fresh curd in hot water, which imparts the finished cheese its characteristic fibrous structure and melting and stretching properties, cf. e.g. “Mozzarella and Pizza cheese” by Paul S. Kindstedt, Cheese: Chemistry, physics and microbiology, Volume 2: Major Cheese groups, second edition, page 337-341, Chapman & Hall. Pizza cheese as used herein includes cheeses suitable for pizzas and they are usually pasta filata/stretched curd cheeses. In one embodiment, the process of the invention further comprises a heat/stretching treatment as for pasta filata cheeses, such as for the manufacturing of Mozzarella.

Dairy Composition

A dairy composition according to the invention may be any composition comprising cow's milk constituents. Milk constituents may be any constituent of milk such as milk fat, milk protein, casein, whey protein, and lactose. A milk fraction may be any fraction of milk such as e.g. skim milk, butter milk, whey, cream, milk powder, whole milk powder, skim milk powder. In a preferred embodiment of the invention the dairy composition comprises milk, skim milk, butter milk, whole milk, whey, cream, or any combination thereof. In a more preferred embodiment the dairy composition consists of milk, such as skim milk, whole milk, cream, or any combination thereof.

In further embodiments of the invention, the dairy composition is prepared, totally or in part, from dried milk fractions, such as, e.g., whole milk powder, skim milk powder, casein, caseinate, total milk protein or buttermilk powder, or any combination thereof. In preferred embodiments, the dairy composition comprises, or consists of, skim milk. In further embodiments, the dairy composition comprises buttermilk.

According to the invention the dairy composition comprises cow's milk and/or one or more cow's milk fractions. The cow's milk and cow's milk fractions may be from any breed of cow (Bos taurus (Bos taurus taurus), Bos indicus (Bos taurus indicus), and crossbreeds of these), such as e.g. Ayrshire, Holstein, Friesian, Brown Swiss, Jersey, Milking Shorthorn, Red Dane, Zebu, and Brahma. In one embodiment the dairy composition comprises cow's milk and/or cow's milk fractions originating from two or more breeds of cow.

The dairy composition for production of cheese may be standardised to the desired composition by removal of all or a portion of any of the milk components and/or by adding thereto additional amounts of such components. This may be done e.g. by separation of milk into cream and skim milk at arrival to the dairy. Thus, the dairy composition may be prepared as done conventionally by fractionating milk and recombining the fractions so as to obtain the desired final composition of the dairy composition. The separation may be made in continuous centrifuges leading to a skim milk fraction with very low fat content (i.e. e.g. <0.5%) and cream with e.g. >35% fat. The dairy composition may be prepared by mixing cream and skim milk. In another embodiment the protein and/or casein content is standardised by the use of Ultra Filtration.

The fat content of the dairy composition may be adjusted to achieve the desired fat content of the cheese by any method known in the art. E.g. it is a common practice in cheese making to adjust the fat content of the milk used for cheese making to a desired ratio of protein to fat (P/F ratio), or more preferably to a desired ratio of casein to fat (C/F ratio). There are close relationships between the P/F and C/F ratios of the cheese milk and the Fat in Dry Matter (FDM) of the cheese, although the relationships are not exact and may vary between cheese plants and with processing conditions. Usually the dairy plant will establish the relationship by daily measurements of P/F or C/F ratio and FDM of the cheese. An approximate relation between the composition of cheese milk and FDM of the cheese is given by:

FDM=(RF×(% fat in milk))/((RF×(% fat in milk)+RP×(% protein in milk))×RS)

wherein RF is the fraction of milk fat retained in the cheese, RP is the fraction of protein retained in the cheese, and RS is the ratio of total solids in cheese to fat and casein. RF, RP and RS depend on the milk and processing conditions and must be determined for the individual dairy plant. Typical values are around RF=0.85, RP=0.8 and RS=1.1.

In a preferred embodiment of the invention the dairy composition to be treated with phospholipase has a fat content of 0-5% fat in dry matter, such as 0-4% fat in dry matter, preferably 0-3% fat in dry matter, more preferably 0-2% fat in dry matter.

In one embodiment of the invention calcium is added to the dairy composition. Calcium may be added to the dairy composition at any appropriate step before and/or during cheese making, such as before, simultaneously with, or after addition of starter culture. Calcium may be added in any suitable form. In a preferred embodiment calcium is added as calcium salt, e.g. as CaCl₂. Any suitable amount of calcium may be added to the dairy composition. The concentration of added calcium will usually be in the range 0.1-5 mM, such as between 1 and 3 mM. If CaCl₂ is added to the dairy composition the amount will usually be in the range 1-50 g pr 100 l of dairy composition, such as in the range 5-30 g pr 100 l dairy composition, preferably in the range 10-20 g pr 100 l dairy composition.

Conventional steps may be taken to secure low bacterial counts in the dairy composition. It is generally preferred not to pasteurise skim milk because heat denatured proteins in the dairy composition may have a negative influence on the coagulation, and retard the ripening of the cheese. The bacterial count of skim milk may thus be lowered by other technologies, such as, for example, by microfiltration or bactofugation. Cream is preferably pasteurised to lower the bacterial count in the product. In another preferred embodiment, the dairy composition is raw, unpasteurised milk. In one embodiment of the invention skim milk is pasteurised.

In an embodiment of the invention, the dairy composition may be subjected to a homogenization process before the production of cheese, such as e.g. in the production of Danish Blue Cheese.

Measurement of Fat Content

The fat content of the dairy composition and/or the cheese may be measured by any method known in the art. The fat content of the dairy composition may e.g. be measured by Infrared absorption using e.g. the Milkoscan® series of instruments (FOSS Electric A/S, Hillerød, Denmark). The fat content and FDM of cheese may e.g. be measured by Near Infrared Spectroscopy using e.g. the FoodScan® Dairy Analyser (FOSS Electric A/S, Hillerød, Denmark).

The Enzymatic Treatment:

The enzymatic treatment in the process of the invention may be conducted by dispersing the phospholipase into the dairy composition, and allowing the enzyme reaction to take place at an appropriate holding-time at an appropriate temperature. The treatment with phospholipase may be carried out at conditions chosen to suit the selected enzyme(s) according to principles well known in the art.

The enzymatic treatment may be conducted at any suitable pH, such as e.g., in the range 2-10, such as, at a pH of 4-9 or 5-7.

In one embodiment the phospholipase treatment is conducted at 3-60° C., such as at 25-45° C. (e.g., for at least 5 minutes, such as, e.g., for at least 10 minutes or at least 30 minutes, e.g., for 5-60 minutes).

The phospholipase is added in a suitable amount to produce the cheese having the desired properties. Preferably, the phospholipase is added in an amount effective to increase cheese yield. A suitable dosage of phospholipase will usually be in the range 0.003-0.7 mg enzyme protein per g milk fat, preferably 0.01-0.3 mg enzyme protein per g milk fat, more preferably, 0.03-0.1 mg enzyme protein per g milk fat.

Enzymes to be Used in the Process of the Invention:

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ (commonly referred to as phospholipase A) which hydrolyze one fatty acyl group (in the sn-1 and sn-2 position, respectively) to form lysophospholipid. Phospholipase B hydrolyzes the remaining fatty acyl group in lysophospholipid.

The enzyme used in the process of the present invention include a phospholipase, such as, phospholipase A₁, phospholipase A₂ and phospholipase B. In the process of the invention the phospholipase treatment may be provided by one or more phospholipase, such as two or more phospholipases, e.g. two phospholipases, including, without limitation, treatment with both type A and B; both type A₁ and A₂; both type A₁ and B; both type A₂ and B; or treatment with two or more different phospholipase of the same type. Included is also treatment with one type of phospholipase, such as A₁, A₂ or B.

Phospholipase A₁ is defined according to standard enzyme EC-classification as EC 3.1.1.32.

Official Name: Phospholipase A₁.

Reaction catalyzed:

phosphatidylcholine+H(2)O<>

2-acylglycerophosphocholine+a fatty acid anion

Comment: has a much broader specificity than EC 3.1.1.4.

Phospholipase A₂ is defined according to standard enzyme EC-classification as EC 3.1.1.4

Official Name: phospholipase A₂.

Alternative Names:phosphatidylcholine 2-acylhydrolase.

lecithinase a; phosphatidase; or phosphatidolipase.

Reaction catalysed:

phosphatidylcholine+H(2)O<>

1-acylglycerophosphocholine+a fatty acid anion

Comment: also acts on phosphatidylethanolamine, choline plasmalogen and phosphatides, removing the fatty acid attached to the 2-position.

Phospholinase B is defined according to standard enzyme EC-classification as EC 3.1.1.5.

Official Name: lysophospholipase.

Alternative Names: lecithinase b; lysolecithinase;

phospholipase B; or PLB.

Reaction catalysed:

2-lysophosphatidylcholine+H(2)O<>glycerophosphocholine+a fatty acid anion

Phospholipase A

Phospholipase A activity may be provided by enzymes having other activities as well, such as e.g. a lipase with phospholipase A activity. The phospholipase A activity may e.g. be from a lipase with phospholipase side activity. In other embodiments of the invention phospholipase A enzyme activity is provided by an enzyme having essentially only phospholipase A activity and wherein the phospholipase A enzyme activity is not a side activity.

Phospholipase A may be of any origin, e.g. of animal origin (such as, e.g. mammalian), e.g. from pancreas (e.g. bovine or porcine pancreas), or snake venom or bee venom. Alternatively, phospholipase A may be of microbial origin, e.g. from filamentous fungi, yeast or bacteria, such as the genus or species Aspergillus, e.g. A. niger, Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer, Sclerotinia, e.g. S. libertiana; Trichophyton, e.g. T. rubrum; Whetzelinia, e.g. W. sclerotiorum; Bacillus, e.g. B. megaterium, B. subtilis; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Proteus, e.g. P. vulgaris; Providencia, e.g. P. stuartli; Salmonella, e.g. S. typhimurium; Serratia, e.g. S. liquefasciens, S. marcescens; Shigella, e.g. S. flexneri; Streptomyces, e.g. S. violaceoruber; Yersinia, e.g. Y. enterocolitica. Thus, phospholipase A may be fungal, e.g. from the class Pyrenomycetes, such as the genus Fusarium, such as a strain of F. culmorum, F. heterosporum, F. solani, or a strain of F. oxysporum. Phospholipase A may also be from a filamentous fungus strain within the genus Aspergillus, such as a strain of Aspergillus awamori, Aspergillus foetidus, Aspergillus japonicus, Aspergillus niger or Aspergillus oryzae. A preferred phospholipase A is derived from a strain of Fusarium, particularly F. oxysporum, e.g. from strain DSM 2672 as described in WO 98/26057, especially described in claim 36 and SEQ ID NO. 2 of WO 98/26057. Another preferred phospholipase A is PLA2 from Streptomyces, such as e.g. PLA2 from S. violaceoruber. In further embodiments, the phospholipase is a phospholipase as disclosed in WO 00/32758 (Novozymes A/S, Denmark).

Phospholipase B

The term “phospholipase B” used herein in connection with an enzyme of the invention is intended to cover an enzyme with phopholipase B activity.

The phospholipase B activity may be provided by enzymes having other activities as well, such as e.g. a lipase with phospholipase B activity. The phospholipase B activity may e.g. be from a lipase with phospholipase B side activity. In other embodiments of the invention the phospholipase B enzyme activity is provided by an enzyme having essentially only phospholipase B activity and wherein the phospholipase B enzyme activity is not a side activity. In one embodiment of the invention, the phospholipase B is not lipases having phospholipase B side activity as defined in WO 98/26057.

The phospholipase B may be of any origin, e.g. of animal origin (such as, e.g. mammalian), e.g. from liver (e.g. rat liver). Alternatively, the phospholipase B may be of microbial origin, e.g. from filamentous fungi, yeasts or bacteria, such as the genus or species Aspergillus, e.g. A. foetidus, A. fumigatus, A. nidulans, A. niger, A. oryzae; Botrytis, e.g. B. cinerea; Candida, e.g. C. albicans; Cryptococcus, e.g. C. neoformans, Escherichia, e.g. E. coli, Fusarium, e.g. F. sporotrichioides, F. venenatum, F. verticillioides; Hyphozyma; Kluyveromyces, e.g. K. lactis; Magnaporte, e.g. M. grisea; Metarhizium, e.g. M. anisopliae; Mycosphaerella, e.g. M. graminicola; Neurospora, e.g. N. crassa; Penicillium, e.g. P. notatum; Saccharomyces, e.g. S. cerevisiae; Schizosaccharomyces, e.g. S. pombe; Torulaspora, e.g. T. delbrueckii; Vibrio; e.g. V. cholerae. A preferred phospholipase B is derived from a strain of Aspergillus, particularly phospholipase LLPL-1 or LLPL-2 from A. niger, e.g. as contained in the Escherichia coli clones DSM 13003 or DSM 13004, or phospholipase LLPL-1 or LLPL-2 from A. oryzae, e.g. as contained in the E. coli clones DSM 13082 or DSM 13083 as described in WO 01/27251, especially described in claim 1 and SEQ ID NOs. 2, 4, 6 or 8 of WO 01/27251.

Enzyme Sources and Formulation

The phospholipase used in the process of the invention may be derived or obtainable from any of the sources mentioned herein. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g. having one or more amino acids which are deleted, inserted and/or substituted, i.e. a recombinantly produced enzyme which is a mutant and/or a fragment of a native amino acid sequence. Within the meaning of a native enzyme are included natural variants. Furthermore, the term “derived” includes enzymes produced synthetically by e.g. peptide synthesis. The term “derived” also encompasses enzymes which have been modified e.g. by glycosylation, phosphorylation etc., whether in vivo or in vitro. The term “obtainable” in this context means that the enzyme has an amino acid sequence identical to a native enzyme. The term encompasses an enzyme that has been isolated from an organism where it is present natively, or one in which it has been expressed recombinantly in the same type of organism or another, or enzymes produced synthetically by e.g. peptide synthesis. With respect to recombinantly produced enzyme the terms “obtainable” and “derived” refers to the identity of the enzyme and not the identity of the host organism in which it is produced recombinantly. Accordingly, the phospholipase may be obtained from a microorganism by use of any suitable technique. For instance, a phospholipase enzyme preparation may be obtained by fermentation of a suitable microorganism and subsequent isolation of a phospholipase preparation from the resulting fermented broth or microorganism by methods known in the art. The phospholipase may also be obtained by use of recombinant DNA techniques. Such method normally comprises cultivation of a host cell transformed with a recombinant DNA vector comprising a DNA sequence encoding the phospholipase in question and the DNA sequence being operationally linked with an appropriate expression signal such that it is capable of expressing the phospholipase in a culture medium under conditions permitting the expression of the enzyme and recovering the enzyme from the culture. The DNA sequence may also be incorporated into the genome of the host cell. The DNA sequence may be of genomic, cDNA or synthetic origin or any combinations of these, and may be isolated or synthesized in accordance with methods known in the art.

Suitable phospholipases are available commercially. As typical examples of the enzymes for practical use, pancreas-derived phospholipase A₂ such as Lecitase® (manufactured by Novozymes A/S, Bagsvaerd, Denmark) is preferably used. A suitable phospholipase B is e.g. Aspergillus niger phospholipase LLPL-2 that can be produced recombinantly in A. niger as described in WO 01/27251.

In the process of the invention the phospholipase may be purified. The term “purified” as used herein covers phospholipase enzyme protein free from components from the organism from which it is derived. The term “purified” also covers phospholipase enzyme protein free from components from the native organism from which it is obtained, this is also termed “essentially pure” phospholipase and may be particularly relevant for phospholipases which are naturally occurring and which have not been modified genetically, such as by deletion, substitution or insertion of one or more amino acid residues.

Accordingly, the phospholipase may be purified, viz. only minor amounts of other proteins being present. The expression “other proteins” relate in particular to other enzymes. The term “purified” as used herein also refers to removal of other components, particularly other proteins and most particularly other enzymes present in the cell of origin of the phospholipase. The phospholipase may be “substantially pure”, i.e. free from other components from the organism in which it is produced, i.e., e.g., a host organism for recombinantly produced phospholipase. Preferably, the enzymes are at least 75% (w/w) pure, more preferably at least 80%, 85%, 90% or even at least 95% pure. In a still more preferred embodiment the phospholipase is an at least 98% pure enzyme protein preparation. In other embodiments the phospholipase is not naturally present in milk.

The terms “phospholipase” includes whatever auxiliary compounds that may be necessary for the catalytic activity of the enzyme, such as, e.g. an appropriate acceptor or cofactor, which may or may not be naturally present in the reaction system.

The phospholipase may be in any form suited for the use in question, such as e.g. in the form of a dry powder or granulate, a non-dusting granulate, a liquid, a stabilized liquid, or a protected enzyme. Granulates may be produced, e.g. as disclosed in U.S. Pat. No. 4,106,991 and U.S. Pat. No. 4,661,452, and may optionally be coated by methods known in the art. Liquid enzyme preparations may, for instance, be stabilized by adding stabilizers such as a sugar, a sugar alcohol or another polyol, lactic acid or another organic acid according to established methods. Protected enzymes may be prepared according to the method disclosed in EP 238,216.

By the process of the invention, the lecithin content of the cheese may be reduced by at least 5%, such as at least 10%, at least 20%, at least 30%, at least 50%, such as in the range of 5-95% compared to a similar cheese making process but without the enzymatic treatment of a phospholipase, as described herein.

In cow milk, the lecithin constitutes normally more than 95% of the phospholipids in milk whereas the lysolecithin is approximately 1% of the phospholipids. Although the phospholipids represent normally less than 1% of the total lipids in cow milk, they play a particularly important role, being present mainly in the milk fat globule membrane. By the process of the present invention the lecithin content in the obtainable cheese may be less than 90%, such as e.g. less than 80%, e.g. less than 60% or less than 50% of the total content of phospholipid in the cheese. The lecithin content may be measured by any method known by the skilled person, e.g. by HPLC.

After treatment with phospholipase the dairy composition may be subjected to a heat treatment. In one embodiment the heat treatment is conducted at a time-temperature combination sufficient to inactivate the enzyme.

The present invention further relates to use of the cheese produced by the process of the invention in pizza, ready-to-eat dishes, processed cheese, or as an ingredient in other food products. Accordingly, the cheese produced according to the process of the invention may be used in further processed food products like processed cheese, pizza, burgers, toast, sauces, dressings, cheese powder or cheese flavours.

In further embodiments, the process of the invention further comprises the step of subjecting the cheese to a heating treatment, such as, e.g., in the range 150-350θ C.

The invention also relates to a cheese obtainable, in particular obtained, by the process of the invention. A cheese according to the invention may have a total fat content of 0-5% fat in dry matter, such as 0-4% fat in dry matter, preferably 0-3% fat in dry matter.

The present invention is further illustrated in the following examples which are not to be in any way limiting to the scope of protection.

### EXAMPLE 1

### Production of Low Fat Mozzarella Cheese from Cow's Milk

Mozzarella cheese can be produced according to the invention in the following way:

The cheese milk can be skimmed milk (e.g. with 0.06% fat) or milk that is standardised to the desired fat content by mixing skim milk (e.g. with 0.06% fat) and cream (e.g. with 40.0% fat).

The cheese milk is treated with phospholipase (e.g. Lecitase®, Novozymes A/S, Bagsvaerd, Denmark) for 1 hour at 35° C. The optimal enzyme dosage can be determined by any method known in the art, e.g. by testing a number of different enzyme dosages within the ranges given in the description of the present application.

A starter culture, e.g. 0.01% of a mixture of starter cultures TA 061 and LH 100 (Chr. Hansen, Milwaukee, Wis.), and rennet, e.g. 0.09% w/w of Chymax (Chr. Hansen, Milwaukee, Wis.), is added to each batch of cheese milk, and the cheese milk is left for 1 hour at 35° C.

After coagulation the coagulum is cut with 0.5″ wire cutters.

The cheese curd is processed after a conventional protocol for Mozzarella cheese.

Actual cheese yield can be calculated as the weight of cheese after stretching relative to the total weight of cheese.

Moisture adjusted cheese yield is expressed as the actual yield adjusted to standard constant level of moisture. Moisture adjusted yield is calculated by multiplying the actual yield and the ratio of actual moisture content to standard moisture, according to the following formula:

Y_{adj}=Y_{act}×1−M_{act}/1−M_{std}

where Y_{adj}=moisture adjusted yield, Y_{adj}=actual yield, M_{act}=actual moisture fraction & M_{std}=standard moisture fraction, e.g. 0.48

The cheese yield can be compared with the cheese yield achieved in a control experiment where cheese is produced in the same way except that the milk is not treated with phospholipase.

1. A method for producing cheese with 5% or less fat in dry matter, comprising:
a) treating a dairy composition comprising cow's milk and/or one or more cow's milk fractions, with a phospholipase;
b) producing cheese from said phospholipase treated dairy composition.

2. The method of claim 1 wherein the fat content of the cheese is 0-4% fat in dry matter.

3. The method of claim 1 wherein the fat content of the cheese is 0-3% fat in dry matter.

4. The method of any of the claims 1-3 wherein the phospholipase is inactivated by a heat treatment after step a) before step b).

5. The method of any of claims 14 wherein the dairy composition comprises one or more cow's milk fractions selected among skim milk, butter milk, whey, cream, or any combination thereof.

6. The method of claim 1 wherein the dairy composition consists of skim milk.

7. The method of any of claims 1-6 wherein the cheese is stretched curd cheese.

8. The method of claim 7 wherein the cheese is Mozzarella cheese.

9. The method of claim 8 wherein the cheese is Pizza Cheese.

10. The method of any of the claims 1-9, further comprising the step of processing the cheese into a food product.

11. The method of claim 10, wherein said food product is selected from the group consisting of pizza, ready-to-eat dishes, toast, burgers, lasagna, dressing, sauces, cheese powder, cheese flavor, and processed cheese.

12. A cheese prepared by the method of any of the claims 1-9.

13. A method for producing cheese, comprising:
a) treating a dairy composition with 5% or less fat in dry matter comprising cow's milk and/or one or more cow's milk fractions, with a phospholipase; and
b) producing cheese from said phospholipase treated dairy composition.
